(19) United States
(12) Patent Application Publication
(10) Pub. No.: US 2015/0371595 A1
(43) Pub. Date: Dec. 24, 2015

(54) GAMMA VOLTAGE GENERATING APPARATUS, GRAY SCALE VOLTAGE GENERATING APPARATUS AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventor: Dan SU, Beijing (CN)

(21) Appl. No.: 14/549,616

(22) Filed: Nov. 21, 2014

(30) Foreign Application Priority Data
Jun. 23, 2014 (CN) 201410283194.0

(51) Int. Cl. G09G 3/36

(52) U.S. Cl. CPC G09G 3/3607; G09G 2320/0276; G09G 2310/027

(57) ABSTRACT

The present invention provides a gamma voltage generating apparatus, comprising: a standard gamma voltage output unit for outputting a plurality of standard gamma voltage values, and a plurality of DACs connected with the standard gamma voltage output unit, wherein, the precisions of at least part of the plurality of DACs are different from those of the other DACs so that when different standard gamma voltage values are input to the plurality of DACs respectively, regulations of the actual gamma voltages output by the plurality of DACs respectively are in a predetermined range. The gray scale voltage generating apparatus according to the present invention comprises the gamma voltage generating apparatus. The display device according to the present invention comprises the gray scale voltage generating apparatus.

### FIELD OF THE INVENTION

The present invention relates to the display device manufacturing field, and specifically to a gamma voltage generating apparatus, a gray scale voltage generating apparatus and a display device.

### BACKGROUND OF THE INVENTION

With the development of liquid crystal display (LCD) technology, consumers' demand for high picture quality of a display device is increasing. The picture quality is mainly determined by the accurate degree of a gray scale voltage generated by a gray scale voltage generating apparatus. As the gray scale voltage is converted from a gamma voltage, the accuracy of the gamma voltage is one of the determinants of the picture quality. Here, the accurate degree of the gray scale voltage generated by the gray scale voltage generating apparatus means proximity between the gray scale voltage generated by the gray scale voltage generating apparatus and the designed gray scale voltage.

In a LCD device, the gray scale voltage generated by the gray scale voltage generating apparatus is obtained from the gamma voltage. FIG. 1 shows a conventional programmable gamma voltage generating apparatus (P-gamma) comprising: a controller, a standard gamma voltage output unit connected with the controller through a timing control unit (BUS) and a plurality of digital to analog converting units (DAC) connected with the standard gamma voltage output unit through a plurality of gamma voltage output channels. Here, the standard gamma voltage output unit is used to output a plurality of standard gamma voltage values which are predetermined known values, and the plurality of DACs have the same number of bits (i.e., the type and precision of the plurality of DACs are the same). Description will be made below with reference to table 1.

TABLE 1

| | | 10 bit | 8 bit | 6 bit | 4 bit | |
|---|---|---|---|---|---|---|
| 14.375 | | 0.014038086 | 0.028076172 | 0.056152344 | 0.112304688 | 10 bit |
| Remark | Design Voltage | Actual Voltage | Actual Voltage | Actual Voltage | Actual Voltage | Regulation(%) |
| VGMA1 | 13.7 | 13.687 | 13.673 | 13.645 | 13.589 | 0.09% |
| VGMA2 | 11.6 | 11.595 | 11.595 | 11.567 | 11.567 | 0.04% |
| VGMA3 | 10.9 | 10.894 | 10.894 | 10.894 | 10.894 | 0.06% |
| VGMA4 | 10.15 | 10.150 | 10.135 | 10.107 | 10.107 | 0.00% |
| VGMA5 | 9.45 | 9.448 | 9.434 | 9.434 | 9.434 | 0.03% |
| VGMA6 | 8.7 | 8.690 | 8.676 | 8.647 | 8.647 | 0.12% |
| VGMA7 | 7.3 | 7.300 | 7.300 | 7.300 | 7.300 | 0.00% |
| VGMA8 | 6.7 | 6.696 | 6.682 | 6.682 | 6.626 | 0.06% |
| VGMA9 | 5.4 | 5.391 | 5.391 | 5.391 | 5.391 | 0.17% |
| VGMA10 | 4.65 | 4.647 | 4.633 | 4.604 | 4.604 | 0.07% |
| VGMA11 | 3.92 | 3.917 | 3.903 | 3.875 | 3.818 | 0.09% |
| VGMA12 | 3.1 | 3.088 | 3.088 | 3.088 | 3.032 | 0.37% |
| VGMA13 | 2.52 | 2.513 | 2.499 | 2.471 | 2.471 | 0.29% |
| VGMA14 | 0.34 | 0.337 | 0.337 | 0.337 | 0.337 | 0.91% |

As shown in table 1, taking a P-gamma including a standard gamma voltage output unit that can output 14 standard gamma voltage values and a DAC with a precision of 10 bits as an example, these 14 standard gamma voltage values are input to corresponding DACs via respective gamma voltage output channels, converted from digital quantities into analog quantities in the DACs, and then output.

From table 1, it can be seen that, regarding standard gamma voltages with a value larger than 3.1, the regulations of the actual gamma voltages output by DACs with a precision of 10 bits are between 0.0% and 0.17%, and regarding standard gamma voltages with a value of 3.1 and below, the regulations of the actual gamma voltages output by DACs with a precision of 10 bits are all over 0.29%, and some even reach 0.91%. Here, regulation refers to ratio of the difference between the standard gamma voltage value input to the DAC and the actual gamma voltage value output by the same to the standard gamma voltage value input to the DAC. Obviously, the smaller the regulation is, the higher the accurate degree of the actual gamma voltage value obtained after conversion of the DAC is.

As can be seen that, for standard gamma voltages with different values, the accurate degrees of the actual gamma voltage values obtained after conversion of a plurality DACs with the same precision may be different, which leads to defects such as residual image or color cast in the display device when the actual gamma voltage values output by the gamma voltage generating apparatus are input to a source driving chip and converted into gray scale voltages to display images with different gray scales, and thus affects the picture quality of the display device.

### SUMMARY OF THE INVENTION

In view of the above-mentioned problems in the existing gamma voltage generating apparatus, the aim of the present invention includes providing a gamma voltage generating apparatus, a gray scale voltage generating apparatus and a display device which can make the display device have better display effect with low cost.

The technical solutions adopted by the present invention to solve the above-mentioned technical problems include a gamma voltage generating apparatus comprising a standard gamma voltage output unit for outputting a plurality of standard gamma voltage values, and a plurality of DACs connected with the standard gamma voltage output unit, wherein, the precisions of at least part of the plurality of DACs are different from those of the other DACs of the plurality of DACs so that when different standard gamma voltage values are input to the plurality of DACs respectively, regulations of actual gamma voltages output by the plurality of DACs respectively are in a predetermined range, and the regulation of the actual gamma voltage refers to a ratio of the difference between the standard gamma voltage value input to the DAC and the actual gamma voltage value output by the same to the standard gamma voltage value input to the DAC.

In the gamma voltage generating apparatus according to the present invention, as the regulations of the actual gamma voltages output by the plurality of DACs are in the predetermined range, the accurate degrees of the actual gamma voltages obtained after conversion of the plurality of DACs are approximately the same, and thus the accurate degrees of the gray scale voltages obtained by inputting the actual gamma voltages output by the gamma voltage generating apparatus according to the present embodiment to a source driving chip and then converting the same are approximately at the same level. As a result, when the display device including the gamma voltage generating apparatus is used to display images with different gray scales, no residual image or color cast would occur.

Preferably, the gamma voltage generating apparatus further comprises:

a controller, in which a corresponding relation between the standard gamma voltage values and the regulations of the actual gamma voltage values output by DACs with different precisions is stored; and

a selector connected between the standard gamma voltage output unit and the plurality of DACs, and configured to, under the control of the controller, select the DAC with a corresponding precision for each of the standard gamma voltage values output by the standard gamma voltage output unit according to the corresponding relation.

Preferably, the standard gamma voltage value input into the DAC with a higher precision, among the plurality of DACs with different precisions, is smaller than that input into the DAC with a lower precision.

Preferably, the gamma voltage generating apparatus further comprises a timing control unit connected between the standard gamma voltage output unit and the controller.

The technical solutions adopted by the present invention to solve the above-mentioned technical problems include a gray scale voltage generating apparatus comprising the above-mentioned gamma voltage generating apparatus.

As the gray scale voltage generating apparatus according to the present invention comprises the above-mentioned gamma voltage generating apparatus, the gray scale voltage generating apparatus has better display effect and lower cost.

Preferably, the gray scale voltage generating apparatus further comprises a source driving chip by which the actual gamma voltages output by the plurality of DACs in the gamma voltage generating apparatus are converted into a plurality of gray scale voltages.

The technical solutions adopted by the present invention to solve the above-mentioned technical problems further include a display device comprising the above-mentioned gray scale voltage generating apparatus.

As the display device according to the present invention comprises the above-mentioned gray scale voltage generating apparatus, the display device has better display effect and lower cost.

### BRIEF DESCRIPTION OF THE DRAWINGS

FIG. 1 is a schematic diagram of an existing gamma voltage generating apparatus.

FIG. 2 is a schematic diagram of a gamma voltage generating apparatus according to an embodiment of the present invention.

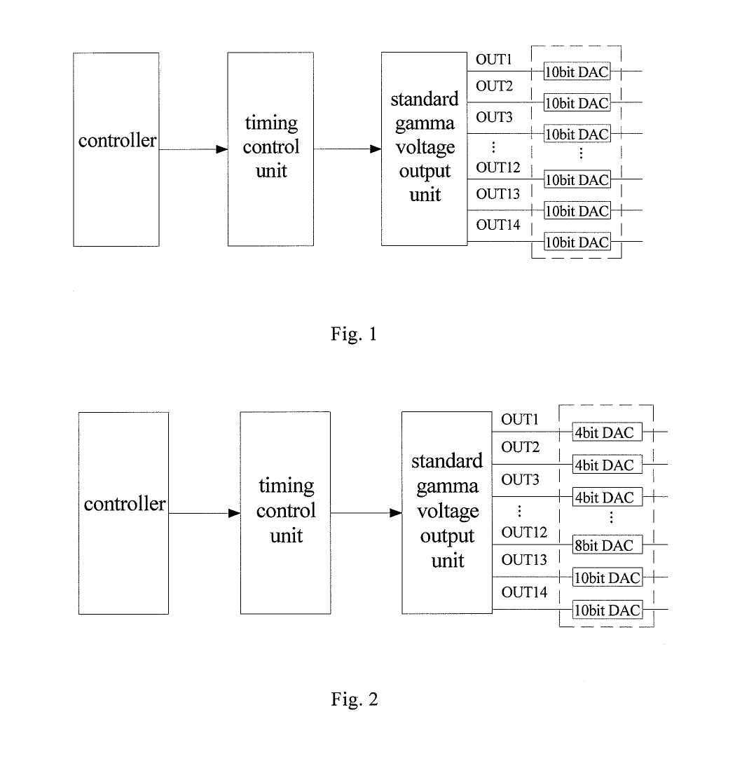

### DETAILED DESCRIPTION OF THE EMBODIMENTS

Detailed description of the present invention will be further made in conjunction with the accompanying drawings and specific implementations so that those skilled in the art can better understand the technical solutions of the present invention.

As shown in FIG. 2, an embodiment of the present invention provides a gamma voltage generating apparatus comprising a standard gamma voltage output unit for outputting a plurality of standard gamma voltage values, and a plurality of DACs connected with the standard gamma voltage output unit. Here, the precisions of at least part of the plurality of DACs are different from those of the other DACs of the plurality of DACs so that when different standard gamma voltage values are input to the plurality of DACs respectively, regulations of actual gamma voltages output by the plurality of DACs are in a predetermined range, wherein, the regulation of the actual gamma voltage refers to a ratio of the difference between the standard gamma voltage value input to the DAC and the actual gamma voltage value output by the same to the standard gamma voltage value input to the DAC.

Here, the regulations of the actual gamma voltages output by the plurality of DACs are controlled in the predetermined range, i.e., the regulations of the actual gamma voltages output by the plurality of DACs are made approximately the same. The predetermined range can be determined according to the application of a display device including the gamma voltage generating apparatus. For example, in the example shown in table 2, the predetermined range may be from 0.40% to 1% (i.e., [0.40%, 1%]). As the regulations of the actual gamma voltages output by the plurality of DACs are in the predetermined range, the accurate degrees of the actual gamma voltages obtained after conversion of the plurality of DACs are approximately the same, and thus the accurate degrees of the gray scale voltages obtained by inputting the actual gamma voltages output by the gamma voltage generating apparatus according to the present embodiment into a source driving chip and then converting the same are approximately at the same level. As a result, when the display device including the gamma voltage generating apparatus provided by the present invention is used to display images with different gray scales, no residual image or color cast would occur.

Next, a gamma voltage generating apparatus including 14 gamma voltage output channels will be taken as an example to better explain the working principle of the gamma voltage generating apparatus according to the present embodiment, and in this example, the predetermined range is [0.40%, 1%].

Firstly, a group of standard gamma voltage values (i.e., 14 standard gamma voltage values) are obtained by measuring and stored in the standard gamma voltage output unit; DACs with different precisions corresponding to the respective standard gamma voltage values are selected according to the corresponding relation of 14 standard gamma voltage values and the regulations of the actual gamma voltage values output by DACs with different precisions; the plurality of standard gamma voltage values are converted, by the selected DACs, into a plurality of actual gamma voltage values with approximately the same regulations which are then output, as shown in table 2.

TABLE 2

| | | 10 bit | 8 bit | 6 bit | 4 bit | | | | |
|---|---|---|---|---|---|---|---|---|---|
| | | 0.014038086 | 0.028076172 | 0.05615234 | 0.112304688 | | | | |
| 14.375 | Design | Actual | Actual | Actual | Actual | 10 bit | 8 bit | 6 bit | 4 bit |
| Remark | Voltage | Voltage | Voltage | Voltage | Voltage | Regulation(%) | Regulation(%) | Regulation(%) | Regulation(%) |
| VGMA1 | 13.71 | 13.687 | 13.673 | 13.645 | 13.589 | 0.17% | 0.27% | 0.47% | 0.88% |
| VGMA2 | 11.65 | 11.595 | 11.595 | 11.567 | 11.567 | 0.47% | 0.47% | 0.71% | 0.71% |
| VGMA3 | 10.95 | 10.894 | 10.894 | 10.894 | 10.894 | 0.52% | 0.52% | 0.52% | 0.52% |
| VGMA4 | 10.18 | 10.150 | 10.135 | 10.107 | 10.107 | 0.30% | 0.44% | 0.71% | 0.71% |
| VGMA5 | 9.48 | 9.448 | 9.434 | 9.434 | 9.434 | 0.34% | 0.49% | 0.49% | 0.49% |
| VGMA6 | 8.72 | 8.690 | 8.676 | 8.647 | 8.647 | 0.35% | 0.51% | 0.83% | 0.83% |
| VGMA7 | 7.35 | 7.300 | 7.300 | 7.300 | 7.300 | 0.68% | 0.68% | 0.68% | 0.68 |
| VGMA8 | 6.72 | 6.696 | 6.682 | 6.682 | 6.626 | 0.35% | 0.56% | 0.56% | 1.40% |
| VGMA9 | 5.43 | 5.391 | 5.391 | 5.391 | 5.391 | 0.73% | 0.73% | 0.73% | 0.73% |
| VGMA10 | 4.67 | 4.647 | 4.633 | 4.604 | 4.604 | 0.50% | 0.80% | 1.40% | 1.40% |
| VGMA11 | 3.92 | 3.917 | 3.903 | 3.875 | 3.818 | 0.09% | 0.44% | 1.16% | 2.59% |
| VGMA12 | 3.11 | 3.088 | 3.088 | 3.088 | 3.032 | 0.70% | 0.70% | 0.70% | 2.50% |
| VGMA13 | 2.53 | 2.513 | 2.499 | 2.471 | 2.471 | 0.68% | 1.23% | 2.34% | 2.34% |
| VGMA14 | 0.34 | 0.337 | 0.337 | 0.337 | 0.337 | 0.91% | 0.91% | 0.91% | 0.91% |

In the above table 2, 14.375 is a reference voltage value, the deviation between the standard gamma voltage value input into the DAC with a precision of 10 bits and the actual gamma voltage value output by the same is 0.014038086; the deviation between the standard gamma voltage value input into the DAC with a precision of 8 bits and the actual gamma voltage value output by the same is 0.028076172; the deviation between the standard gamma voltage value input into the DAC with a precision of 6 bits and the actual gamma voltage value output by the same is 0.05615234; the deviation between the standard gamma voltage value input into the DAC with a precision of 4 bits and the actual gamma voltage value output by the same is 0.112304688. As can be seen from table 2 that, in this case, as DACs corresponding to the first to the seventh gamma voltage output channels respectively, DACs with a precision of 4 bits are selected which output actual gamma voltages with regulations of 0.88%, 0.71%, 0.52%, 0.71%, 0.49%, 0.83%, and 0.68% respectively; as DACs corresponding to the eighth and the ninth gamma voltage output channels respectively, DACs with a precision of 6 bits are selected which output actual gamma voltages with regulations of 0.56% and 0.73% respectively; as DACs corresponding to the tenth to the twelfth gamma voltage output channels respectively, DACs with a precision of 8 bits are selected which output actual gamma voltages with regulations of 0.80%, 0.44% and 0.70% respectively; as DACs corresponding to the thirteenth and the fourteenth gamma voltage output channels respectively, DACs with a precision of 10 bits are selected which output actual gamma voltages with regulations of 0.68% and 0.91% respectively.

It can be seen that, each of the selected DACs is the one with a precision that the deviation between the actual gamma voltage value output by the DAC and the standard gamma voltage value input into the DAC is the largest, so that the actual gamma voltage values output by different gamma voltage output channels respectively may be balanced, and the brightness of the display panel may be more uniform. Besides, the higher the precision of the DAC is, the higher the price thereof is. In the gamma voltage generating apparatus provided in the present invention, not all of the DACs are DAC with high precision. Therefore, in this embodiment, by selecting DACs with different precisions such that the regulations of the actual gamma voltage values corresponding to different standard gamma voltage values respectively are approximately the same, not only is the picture quality of the display device including the gamma voltage generating apparatus improved, but also the product cost is lowered.

In order to make the gamma voltage generating apparatus according to this embodiment more intelligent, preferably, the gamma voltage generating apparatus further comprises a selector and a controller. The corresponding relation of the standard gamma voltage values and the regulations of the actual gamma voltage values output by DACs with different precisions is stored in the controller; the selector is connected between the standard gamma voltage output unit and the plurality of DACs, and can select the DAC with a corresponding precision for each of the standard gamma voltage values output by the standard gamma voltage output unit according to the corresponding relation under the control of the controller.

Specifically speaking, when the standard gamma voltage output unit outputs one standard gamma voltage value through a certain gamma voltage output channel, the controller controls the selector to select a DAC with the corresponding precision to output the actual gamma voltage value according to the corresponding relation of the standard gamma voltage values and the regulations of the actual gamma voltage values output by DACs with different precisions, and at the same time, the same operation is done to the other standard gamma voltage values so that the regulations of the actual gamma voltage values corresponding to different standard gamma voltage values are approximately the same, thus improving the picture quality of the display device including the gamma voltage generating apparatus.

To achieve a better display effect, preferably, the standard gamma voltage value input into the DAC with a higher precision, among the plurality of DACs with different precisions, is smaller than that input into the DAC with a lower precision. For example, as shown in table 2, the standard gamma voltage values (which are 2.53 and 0.34 respectively) input into the DACs (which are both DACs with a precision of 10 bits) corresponding to the thirteenth and fourteenth gamma voltage output channels are both less than those (which are 6.72 and 5.43 respectively) input into the DACs (which are both DACs with a precision of 6 bits) corresponding to the eighth and ninth gamma voltage output channels.

Also, the gamma voltage generating apparatus according to the present embodiment may further comprise a timing control unit which is connected between the standard gamma voltage output unit and the controller. The timing control unit may be BUS.

Another embodiment of the present invention provides a gray scale voltage generating apparatus comprising the above-mentioned gamma voltage generating apparatus. Of course, the gray scale voltage generating apparatus further comprises a source driving chip by which the actual gamma voltages output by the plurality of DACs in the gamma voltage generating apparatus are converted into a plurality of gray scale voltages.

As the gray scale voltage generating apparatus in this embodiment comprises the gamma voltage generating apparatus according to the above-mentioned embodiment, the display device including said gray scale voltage generating apparatus has better display effect and lower cost.

Another embodiment according to the present invention further provides a display device comprising the gray scale voltage generating apparatus according to the above-mentioned embodiment.

The display device may be any product or part with a display function, such as, mobile phone, tablet computer, TV, displayer, notebook computer, digital photo frame, and navigator etc.

As the display device according to the present embodiment comprises the gray scale voltage generating apparatus according to the above-mentioned embodiment, the display device has a better display effect and lower cost.

Of course, the display device according to the present embodiment may further comprise other conventional components such as a display driving unit etc.

It should be understood that, the above-mentioned embodiments are exemplary implementations used to explain the principle of the present invention, but the present invention is not limited thereto. Any person skilled in the art can make various modifications and improvements to the technical solutions of the present invention without departing from the spirit and essence of the present invention, and these modifications and improvements will fall within the scope of the technical solutions of the present invention.

1. A gamma voltage generating apparatus, comprising: a standard gamma voltage output unit for outputting a plurality of standard gamma voltage values, and a plurality of digital to analog converting units (DAC) connected with the standard gamma voltage output unit, wherein, precisions of at least part of the plurality of DACs are different from the other DACs of the plurality of DACs so that when different standard gamma voltage values are input to the plurality of DACs respectively, regulations of actual gamma voltages output by the plurality of DACs respectively are in a predetermined range, and the regulation of the actual gamma voltage refers to a ratio of the difference between the standard gamma voltage value input to the DAC and the actual gamma voltage value output by the same to the standard gamma voltage value input to the DAC.

2. The gamma voltage generating apparatus according to claim 1, further comprising:
a controller, in which a corresponding relation between the standard gamma voltage values and the regulations of the actual gamma voltage values output by DACs with different precisions is stored; and
a selector connected between the standard gamma voltage output unit and the plurality of DACs, and configured to, under the control of the controller, select the DAC with a corresponding precision for each of the standard gamma voltage values output by the standard gamma voltage output unit according to the corresponding relation.

3. The gamma voltage generating apparatus according to claim 1, wherein, the standard gamma voltage value input into the DAC with a higher precision, among the plurality of DACs with different precisions, is smaller than that input into the DAC with a lower precision.

4. The gamma voltage generating apparatus according to claim 2, wherein, the standard gamma voltage value input into the DAC with a higher precision among the plurality of DACs with different precisions, is smaller than that input into the DAC with a lower precision.

5. The gamma voltage generating apparatus according to claim 2, further comprising a timing control unit connected between the standard gamma voltage output unit and the controller.

6. A gray scale voltage generating apparatus, comprising a gamma voltage generating apparatus which comprises: a standard gamma voltage output unit for outputting a plurality of standard gamma voltage values, and a plurality of digital to analog converting units (DAC) connected with the standard gamma voltage output unit, wherein, precisions of at least part of the plurality of DACs are different from the other DACs of the plurality of DACs so that when different standard gamma voltage values are input to the plurality of DACs respectively, regulations of the actual gamma voltages output by the plurality of DACs respectively are in a predetermined range, and the regulation of the actual gamma voltage is a ratio of the difference between the standard gamma voltage value input to the DAC and the actual gamma voltage value output by the same to the standard gamma voltage value input to the DAC.

7. The gray scale voltage generating apparatus according to claim 6, further comprising a source driving chip by which the actual gamma voltages output by the plurality of DACs in the gamma voltage generating apparatus are converted into a plurality of gray scale voltages.

8. The gray scale voltage generating apparatus according to claim 6, wherein, the gamma voltage generating apparatus further comprises:
a controller, in which a corresponding relation between the standard gamma voltage values and the regulations of the actual gamma voltage values output by DACs with different precisions is stored; and
a selector connected between the standard gamma voltage output unit and the plurality of DACs, and configured to, under the control of the controller, select the DAC with a corresponding precision for each of the standard gamma voltage values output by the standard gamma voltage output unit according to the corresponding relation.

9. The gray scale voltage generating apparatus according to claim 6, wherein, the standard gamma voltage value input into the DAC with a higher precision, among the plurality of DACs with different precisions, is smaller than that input into the DAC with a lower precision.

10. The gray scale voltage generating apparatus according to claim 8, wherein, the standard gamma voltage value input into the DAC with a higher precision, among the plurality of DACs with different precisions, is smaller than that input into the DAC with a lower precision.

11. A display device, comprising the gray scale voltage generating apparatus according to claim 6.

12. The display device according claim 11, wherein, the gray scale voltage generating apparatus further comprises a source driving chip by which the actual gamma voltages output by the plurality of DACs in the gamma voltage generating apparatus are converted into a plurality of gray scale voltages.

13. The display device according to claim 11, wherein, the gamma voltage generating apparatus included in the gray scale voltage generating apparatus further comprises:
a controller, in which a corresponding relation between the standard gamma voltage values and the regulations of the actual gamma voltage values output by DACs with different precisions is stored; and
a selector connected between the standard gamma voltage output unit and the plurality of DACs, and configured to, under the control of the controller, select the DAC with a corresponding precision for each of the standard gamma voltage values output by the standard gamma voltage output unit according to the corresponding relation.

14. The display according to claim 11, wherein, the standard gamma voltage value input into the DAC with a higher precision, among the plurality of DACs with different precisions, is smaller than that input into the DAC with a lower precision.
